(19) United States
(12) Patent Application Publication
(10) Pub. No.: US 2022/0037679 A1
(43) Pub. Date: Feb. 3, 2022

(54) METHOD FOR PRODUCING A METAL-SUPPORTED FUEL CELL AND/OR ELECTROLYZER UNIT

(71) Applicant: Robert Bosch GmbH, Stuttgart (DE)

(72) Inventors: Andreas Haeffelin, Vaihingen (DE); Friedrich Kneule, Rutesheim (DE)

(21) Appl. No.: 17/276,883

(22) PCT Filed: Sep. 18, 2019
(86) PCT No.: PCT/EP2019/074975

§ 371 Date: Mar. 17, 2021

(30) Foreign Application Priority Data
Sep. 21, 2018 (DE) 10 2018 216 101.1

(51) Int. Cl. H01M 8/0273; H01M 8/1004; C25B 9/63

(52) U.S. Cl. CPC H01M 8/0273; H01M 2008/1293; C25B 9/63; H01M 8/1004

(57) ABSTRACT

The invention relates to a method for producing a metal-supported fuel cell and/or electrolyzer unit, in particular a metal-supported solid oxide fuel cell unit, wherein the metal-supported fuel cell and/or electrolyzer unit comprises at least one electrode unit (14a; 4b; 14c; 14f) with at least two functional layers (16a, 18a;16b, 18b;16c, 8c; 16f, 18f), and the metal-supported fuel cell and/or electrolyzer unit comprises at least one metal support device for supporting the electrode unit (14a; 14b; 14c; 14f). According to the invention, the metal support device and the electrode unit (14a; 14b; 14c; 14f) which has the at least two functional layers (16a, 8a; 16c, 18c; 16f, 18f) are produced separately.

### BACKGROUND

A method for producing a metal-supported fuel cell and/or electrolyzer unit, in particular a metal-supported solid oxide fuel cell unit, wherein the metal-supported fuel cell and/or electrolyzer unit comprises at least one electrode unit with at least two functional layers, and wherein the metal-supported fuel cell and/or electrolyzer unit comprises at least one metal support device for supporting the electrode unit, has already been proposed.

### SUMMARY

The invention starts from a method for producing a metal-supported fuel cell and/or electrolyzer unit, in particular a metal-supported solid oxide fuel cell unit, wherein the metal-supported fuel cell and/or electrolyzer unit comprises at least one electrode unit with at least two functional layers, and wherein the metal-supported fuel cell and/or electrolyzer unit comprises at least one metal support device for supporting the electrode unit.

The proposal is that the metal support device and the electrode unit which has the at least two functional layers are produced separately. In this context, a “fuel cell and/or electrolyzer unit” should be interpreted, in particular, to mean at least part, in particular a subassembly, of a fuel cell, in particular of a solid oxide fuel cell, and/or of an electrolyzer, in particular of a high-temperature electrolyzer. In particular, the metal-supported fuel cell and/or electrolyzer unit can also comprise the entire fuel cell, in particular the entire solid oxide fuel cell, the entire electrolyzer, in particular the entire high-temperature electrolyzer, a stack of fuel cells and/or electrolyzers and/or a compound structure comprising a plurality of stacks of fuel cells and/or electrolyzers. The metal-supported fuel cell and/or electrolyzer unit is preferably provided for the purpose of burning a fuel while supplying an oxidant in a combustion process to obtain electric energy. As an alternative or in addition, the metal-supported fuel cell and/or electrolyzer unit is provided for the purpose of splitting a fluid into at least two constituents in a splitting process while supplying electric energy. “Provided” should be interpreted, in particular, to mean specially set up, specially designed and/or specially equipped. In particular, the fact that an object is provided for a particular function should be interpreted to mean that the object performs and/or carries out this particular function in at least one state of use and/or operation.

The metal-supported fuel cell and/or electrolyzer unit preferably comprises at least one functional layer, in particular at least three functional layers. A “functional layer of a metal-supported fuel cell and/or electrolyzer unit” should preferably be interpreted, in particular, to mean a layer which participates directly in the combustion process and/or splitting process carried out by means of the metal-supported fuel cell and/or electrolyzer unit. In particular, at least one, preferably two, functional layers is/are designed as an electrode layer, in particular for use as a cathode and/or anode. At least one electrode layer is preferably designed as an oxidant electrode, in particular for contact with the oxidant and/or a cleavage product. At least one electrode layer is preferably designed as a fuel electrode, in particular for contact with the fuel and/or another cleavage product. At least one functional layer is preferably designed as a separating layer, in particular as an electrolyte layer. At least one separating layer is preferably arranged on at least one electrode layer, in particular between two electrode layers. The electrode unit preferably comprises at least one of the functional layers designed as an electrode layer. The electrode unit preferably comprises at least the functional layer designed as a separating layer. In particular, the electrode unit is designed as a membrane electrode assembly (MEA).

The metal support device is preferably provided for mechanical and/or thermal stabilization of the electrode unit. The metal support device preferably has at least one electrode contact surface, in particular on a largest outer surface of the metal support device, in particular for application of the electrode unit to the metal support device. In particular, the electrode unit is applied to the metal support device in at least one method step. A maximum extent of the electrode contact surface is preferably greater than a maximum extent of one of the, preferably all of the, functional layers. In particular, a maximum size of the electrode contact surface is preferably greater than a maximum size of one of the, preferably all of the, functional layers. At least in a direction perpendicular to the electrode contact surface, the metal support device preferably has a maximum extent which is greater than a layer thickness, preferably more than twice as great as a layer thickness, particularly preferably more than five times as great as a layer thickness, of one of the functional layers, in particular of all of the functional layers together. In particular, the metal support device is produced at least partially, and in particular the electrode contact surface is produced, from a metal foil, a metal sheet and/or from a metal plate. The metal support device is preferably manufactured at least substantially from at least one metal in at least one method step. The statement that an object is manufactured “substantially from a metal” should be interpreted, in particular, to mean that a proportion of the volume of the material is more than 25%, preferably more than 50%, particularly preferably more than 75%, of a total volume of the object. The metal support device is preferably manufactured at least substantially from a metal that is stable at high temperatures. “Stable at high temperatures” should be interpreted, in particular, to mean dimensionally stable and/or chemically stable up to temperatures of at least 500° C., preferably up to temperatures of at least 850° C., particularly preferably up to temperatures of at least 1200° C. It is conceivable that the metal support device comprises component elements which are manufactured from a ceramic, a plastic or some other material, e.g. for electric and/or thermal isolated fixing of the metal support device and/or of individual component elements of the metal support device.

The electrode unit is produced, in particular at least preformed, in at least one electrode production step. At least one blank, a compact, a green compact, a white compact or the like of the electrode unit is preferably produced in the electrode production step. Preferably, in at least one method step after application to the metal support device, the electrode unit is converted from a preformed state into a final state, in particular by sintering and/or by curing. In particular, the at least two functional layers of the electrode unit are arranged one upon the other, in particular being fixed one upon the other, in the electrode production step.

The metal support device is preferably produced in at least one metal support production step. At least one main body, in particular a metal sheet, of the metal support device is preferably structured in the metal support production step. In particular, at least one fluid channel is let into the main body in the metal support production step. The at least one fluid channel is preferably let into the main body of the metal support device by means of a forming process, in particular by means of stamping, embossing, milling, laser boring, laser cutting or the like.

The statement that an object is produced “separately” from another object should be interpreted, in particular, to mean that the object is produced independently of the other object, in particular irrespective of the presence of the other object at a production location of the object, in particular irrespective of a current state of the other object during a production step for the object, in particular irrespective of the physical existence of the other object. In particular, the metal support device and the electrode unit are in a spatially distanced state and/or in a state in which they can at least be separated nondestructively after the respective separate production steps, in particular up to downstream combination. It is conceivable for production parameters and/or target values for object parameters, in particular dimensioning of the metal support device and/or of the electrode unit, to be matched to one another in a planning process preceding at least one separate production step. The electrode production step is preferably carried out separately from the metal support production step. In particular, the electrode production step can be carried out before the metal support production step, after the metal support production step and/or at least partially in parallel with the metal support production step. In particular, the electrode production step is carried out in a manner spatially separate from the metal support production step, in particular in a manner spatially separate from the metal support device. The electrode unit is preferably applied to the metal support device, in particular to the electrode contact surface of the metal support device, in a method step downstream of the electrode production step, and in particular of the metal support production step. In particular, the electrode unit, in particular the at least two functional layers of the electrode unit, is/are applied to the metal support device in a single method step, in particular in a method step configured differently from the electrode production step. In particular, the electrode unit is applied in an at least preformed state to the metal support device. In particular, the at least two functional layers of the electrode unit are applied to the metal support device in a state in which they are fixed on one another.

By virtue of the method configuration according to the invention, the metal-supported fuel cell and/or electrolyzer unit can advantageously be produced in a manner which is suitable for mass production and/or in an advantageously low-cost way. In particular, the electrode unit and the metal support device can be manufactured in advance. In particular, the electrode unit and the metal support device can be implemented as semifinished products, in particular standardized semifinished products.

It is furthermore proposed that, in at least one method step, the electrode unit is applied, in particular in layers, to a flexible transport support element before application of the electrode unit to the metal support device. The flexible transport support element preferably has at least one electrode application surface, in particular for application of the electrode unit to the flexible transport support element. In the electrode production step, the electrode unit is preferably applied in layers to the flexible transport support element, in particular to the electrode application surface. The flexible transport support element is preferably designed in such a way that it can be rolled up, in particular together with the electrode unit. In particular, the flexible transport support element is designed as a foil or sheet. The flexible transport support element is preferably provided for pre-manufacture, transport and/or storage of the electrode unit and, in particular, for downstream production of a metal-supported fuel cell and/or of an electrolyzer. In the electrode production step, the functional layer designed as an electrode layer is preferably applied to the flexible transport support element. In a further electrode production step, the functional layer designed as a separating layer is preferably applied to the functional layer designed as an electrode layer. Alternatively, the functional layer designed as a separating layer is applied to the flexible transport support element in the electrode production step, and/or the functional layer designed as an electrode layer is applied to the functional layer designed as a separating layer in the further electrode production step. The at least two functional layers are preferably applied to the flexible transport support element by means of a printing process, e.g. by a doctoring process, by a spraying process, by an inkjet process, by an offset printing process or the like. At least one functional layer with a maximum layer thickness of less than 100 μm, preferably of less than 50 μm, particularly preferably of less than 25 μm, is preferably applied. At least one functional layer with a minimum layer thickness of more than 25 nm, preferably of more than 50 nm, particularly preferably of more than 75 nm, is preferably applied. At least one functional layer is preferably manufactured at least substantially from a ceramic. It is conceivable that the electrode unit is covered with a protective layer after application to the flexible transport support element, in particular for transport and/or storage. By virtue of the configuration according to the invention, the pre-manufactured electrode unit can advantageously be stored and/or transported in a compact manner.

It is furthermore proposed that, in at least one method step, after the electrode unit has been applied to the metal support device, a transport support element, in particular a water-soluble transport support element, is removed for the transport of the electrode unit. The procedure followed with the, in particular water-soluble, transport support element in the electrode production step is analogous to that followed with the flexible transport support element. In particular, the, in particular water-soluble, transport support element is identical with the flexible transport support element. However, it is also conceivable that the, in particular, water-soluble, transport element and the flexible transport support element form separately formed component elements of a transport unit, in particular a transport unit of layered construction. The transport support element is preferably of water-soluble design. The transport support element is preferably manufactured substantially from Trucal. The transport support element is preferably removed from the electrode unit in at least one detachment step. The transport support element is preferably at least partially wetted in the detachment step. In particular, it is detached and/or at least partially dissolved in the detachment step of the transport support element. The transport support element is preferably removed before sintering and/or curing of the electrode unit. By virtue of the configuration according to the invention, a material with an advantageously high surface finish, in particular in respect of roughness and porosity, can be used for the transport support element. In particular, it is possible to use for the transport support element a material which achieves an advantageously high wettability, an advantageously high thickness quality and/or an advantageously high print image stability for the functional layers. In particular, it is possible to dispense with removal of combustion residues of the transport support element which are formed as a result of sintering.

It is furthermore proposed that an additional functional layer, in particular a functional layer designed as an oxidant electrode, is applied to the electrode unit in at least one method step before application of the electrode unit to the metal support device. The additional functional layer is preferably applied to the functional layer, designed as a separating layer, of the electrode unit in at least one method step. In particular, the additional functional layer is applied to the electrode unit situated on the transport support element. In particular, the additional functional layer is fixed on the electrode unit. In particular, the electrode unit is applied to the metal support device together with the additional functional layer in at least one method step. In particular, the additional functional layer is arranged on the electrode contact surface, in particular between the electrode unit and the metal support device. The additional functional layer is preferably designed as an electrode layer. In particular, the additional functional layer is designed as an oxidant electrode. Alternatively, the additional functional layer is designed as a fuel electrode. However, it is also conceivable for the additional functional layer to be designed as a separating layer, in particular for electric insulation of the electrode unit from the metal support device. By virtue of the configuration according to the invention, the method can be carried out in an advantageously small number of individual steps and/or with an advantageously small expenditure of time. In particular, all the functional layers of the fuel cell and/or electrolyzer unit can advantageously be manufactured in advance, in particular being preformed.

It is furthermore proposed that an additional functional layer, in particular a functional layer designed as an oxidant electrode, is applied to the electrode unit in at least one method step after application of the electrode unit to the metal support device. An additional functional layer, in particular an additional functional layer designed as an oxidant electrode, is preferably applied to the electrode unit in at least one method step after sintering and/or curing of the electrode unit. The additional functional layer is preferably baked onto the electrode unit in at least one method step. The additional functional layer is preferably applied to the functional layer, designed as a separating layer, of the electrode unit. The additional functional layer is preferably applied as an oxidant electrode. By virtue of the configuration according to the invention, sintering and/or curing can advantageously be matched in a material-specific way to the electrode unit. In particular, it is advantageously possible to avoid restrictions in process parameters for sintering and/or curing, e.g. temperature and/or pressure. In particular, degradation processes of the additional functional layer during sintering and/or curing can be avoided.

Moreover, the invention starts from a metal support device for a metal-supported fuel cell and/or electrolyzer unit, in particular for a metal-supported fuel cell and/or electrolyzer unit produced by a method according to the invention, for supporting an electrode unit of the metal-supported fuel cell and/or electrolyzer unit with at least one electrode contact surface. It is proposed that the electrode contact surface is of structured design. The metal support device preferably comprises at least one main body. The electrode contact surface is preferably designed at least as a partial region of a surface, in particular of a largest outer surface, of the main body. The main body is preferably of flat design. In particular, the main body comprises a maximum extent, at least in a direction perpendicular to the electrode contact surface, in particular to the largest outer surface, which is less than a maximum extent, preferably less than 1/10 of a maximum extent, particularly preferably less than 1/30 of a maximum extent, of the electrode contact surface, in particular of the largest outer surface. A maximum radius of curvature of a curvature of the largest outer surface, in particular of the electrode contact surface, is preferably greater, in particular more than three times as great as, particularly preferably more than five times as great as, the maximum extent of the largest outer surface, in particular of the electrode contact surface. The main body is preferably designed as a metal foil, a metal sheet and/or a metal plate. In particular, the maximum extent in the direction perpendicular to the electrode contact surface, in particular to the largest outer surface, is at least less than 1 mm, preferably less than 750 μm, particularly preferably less than 500 μm. The statement that the electrode contact surface is of “structured” design, should be interpreted, in particular, to mean that the metal support device has structure elements that are arranged in and/or on the electrode contact surface. In particular, the structure element limits the electrode contact surface. For example, the metal support device comprises, as structure elements on the electrode contact surface, grooves, recesses, ribs, knobs, wells, channels, pins or the like. The metal support device preferably comprises at least one fluid channel. The fluid channel is preferably let into the main body, in particular at the electrode contact surface. As an alternative or in addition, the metal support device has at least one structure element, arranged on the electrode contact surface, for conducting fluid. The fluid channel preferably comprises at least one outlet opening in the electrode contact surface. The fluid channel preferably comprises at least one inlet opening in a partial region of the surface of the main body which is of different design from the electrode contact surface, in particular on a side of the metal support device facing away from the electrode contact surface. In particular, the fluid channel is designed as an aperture through the main body. The electrode contact surface preferably surrounds the outlet opening of the fluid channel completely. The fluid channel preferably structures the electrode contact surface. In particular, the fluid channel forms a recess in the electrode contact surface. By virtue of the configuration according to the invention, the electrode unit can be supplied with fluid, in particular with fuel and/or oxidant, in particular simultaneously, in a manner supported in an advantageously secure way, and in an advantageously reliable manner.

It is furthermore proposed that the metal support device comprises at least one fluid channel having a large-area outlet opening arranged on the electrode contact surface. The expression “large-area outlet opening” should be interpreted, in particular, to mean that an imaginary surface lying, in particular, in a plane parallel to the electrode contact surface and having a size defined by the outlet opening has a maximum area which is at least greater than 1%, preferably greater than 2%, particularly preferably greater than 3%, in comparison with a maximum area of the electrode contact surface and/or in comparison with a total channel surface. A “total channel surface” should be interpreted, in particular, to mean a maximum area of a totality of imaginary surfaces, in particular surfaces lying in the plane parallel to the electrode contact surface, which have a size defined by the respective outlet opening of a fluid channel of a totality of the fluid channels of the metal support device. The metal support device comprises precisely one fluid channel, for example. The precisely one fluid channel preferably has a meandering, spiral and/or branched large-area outlet opening. For example, the metal support device comprises at least one slot-shaped fluid channel, preferably a plurality of slot-shaped fluid channels arranged substantially parallel. Here, the expression “substantially parallel” should be interpreted, in particular, to mean an orientation of a direction relative to a reference direction, in particular in a plane, wherein the direction has a deviation from the reference direction of, in particular, less than 8°, advantageously less than 5°, and particularly advantageously less than 2°. In particular, the large-area outlet opening of the, in particular slot-shaped, fluid channel has at least one maximum longitudinal extent in at least one direction which corresponds at least substantially to a maximum extent of the electrode contact surface in said direction. The statement that one section “corresponds substantially” to another section should be interpreted, in particular, to mean that the section comprises at least 25%, preferably more than 50%, particularly preferably more than 75%, of the other section. For example, the metal support device comprises a plurality of fluid channels, in particular fluid channels of substantially identical construction, which are let into the main body, in particular in a manner distributed at regular and/or irregular intervals. By virtue of the configuration according to the invention, a flow resistance of the metal support device, particularly in respect of the fuel and/or the oxidant, can advantageously be kept low. In particular, an advantageously large proportion of the area of the functional layer arranged on the metal support device can be supplied directly with the fluid during operation of the fuel cell and/or electrolyzer unit. In particular, the metal support device is advantageously flexible, especially for processing, transport and/or storage.

It is furthermore proposed that the metal support device comprises a fluid distribution element arranged on the electrode contact surface. The fluid distribution element is preferably arranged on at least one fluid channel. In particular, the fluid distribution element is connected fluidically to at least one fluid channel. In particular, at least one fluid channel opens into the fluid distribution element. An outlet opening of the fluid distribution element at the electrode contact surface is preferably larger than an outlet opening of the fluid channel which opens into the fluid distribution element. The distribution element is preferably designed as a groove, in particular on a branching and/or spiral groove, on the electrode contact surface. However, it is also conceivable for the fluid distribution element to be designed as a widening in the cross section of the fluid channel. By virtue of the configuration according to the invention, porosity, in particular through-porosity, of the metal support device can advantageously be kept small. In particular, the metal support device can be configured in an advantageously stable manner.

It is furthermore proposed that the metal support device comprises an expanded metal element for conducting fluid, in particular for the formation of the electrode contact surface. In particular, the expanded metal element has at least one area with diamond meshes, long bar meshes, hexagonal meshes, circular meshes, square meshes and/or special meshes. The expanded metal element preferably forms the main body of the metal support device. Meshes of the expanded metal element preferably form fluid channels. However, it is also conceivable that the expanded metal element is fixed to a main body, in particular an additional main body. In particular, the expanded metal element is arranged, in particular fixed, on the largest outer side of the additional main body of the metal support device. In particular, the side of the expanded metal facing away from the largest outer side of the additional main body forms the electrode contact surface of the metal support device. Preferably, at least one fluid channel opens into a mesh of the expanded metal element. In particular, at least one mesh is designed as a large-area outlet opening of the fluid channel. Alternatively, at least one mesh of the expanded metal element forms a fluid distribution element. The expanded metal element is preferably made at least substantially of metal, in particular of the same metal as the main body, and/or of a plastic. By virtue of the configuration according to the invention, the metal support device can be produced in an advantageously simple and/or advantageously low-cost manner.

Furthermore, a metal-supported fuel cell and/or electrolyzer unit, in particular a metal-supported solid oxide fuel cell unit, is proposed which is produced by a method according to the invention and/or comprises a metal support device according to the invention. By virtue of the configuration according to the invention, an advantageously compact, mechanically stable and/or vibration-resistant metal-supported fuel cell and/or electrolyzer unit can be provided. In particular, it is possible to provide a metal-supported fuel cell and/or electrolyzer unit which is advantageously suitable for use in mobile applications. In particular, an advantageously low-cost metal-supported fuel cell and/or electrolyzer unit can be made available.

The method according to the invention, the metal support device according to the invention and/or the metal-supported fuel cell and/or electrolyzer unit according to the invention should not be restricted here to the use and embodiment described above. In particular, the method according to the invention, the metal support device according to the invention and/or the metal-supported fuel cell and/or electrolyzer unit according to the invention can have a number of individual elements, components and units as well as method steps which deviates from a number mentioned herein in order to fulfill a mode of operation described herein. In addition, for the ranges of values indicated in the present disclosure, values which lie within said limits are also intended to be disclosed and considered to be usable as desired.

### BRIEF DESCRIPTION OF THE DRAWINGS

Further advantages will become apparent from the following description of drawings. Six exemplary embodiments of the invention are illustrated in the drawings. The drawing, the description and the claims contain numerous features in combination. A person skilled in the art will expediently also consider the features individually and combine them to form useful further combinations.

In the drawings:

FIG. 1 shows a schematic illustration of a metal-supported fuel cell and/or electrolyzer unit according to the invention,

FIG. 2 shows a schematic illustration of a method according to the invention,

FIG. 3 shows a schematic illustration of a metal support device according to the invention,

FIG. 4 shows a schematic illustration of a cross section through the fuel cell and/or electrolyzer unit according to the invention,

FIG. 5 shows a schematic illustration of an alternative metal-supported fuel cell and/or electrolyzer unit according to the invention,

FIG. 6 shows a schematic illustration of an alternative method according to the invention for producing the alternative metal-supported fuel cell and/or electrolyzer unit according to the invention,

FIG. 7 shows a schematic illustration of an alternative metal support device according to the invention,

FIG. 8 shows a schematic illustration of a further metal-supported fuel cell and/or electrolyzer unit according to the invention,

FIG. 9 shows a schematic illustration of a further method according to the invention for producing the further metal-supported fuel cell and/or electrolyzer unit according to the invention,

FIG. 10 shows a schematic illustration of a further metal support device according to the invention,

FIG. 11 shows a schematic illustration of a further alternative metal support device according to the invention,

FIG. 12 shows a schematic illustration of another metal support device according to the invention, and

FIG. 13 shows a schematic illustration of a cross section through an additional metal support device according to the invention.

### DETAILED DESCRIPTION

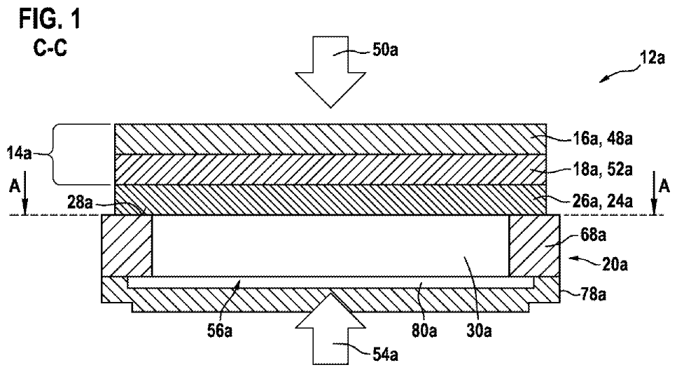

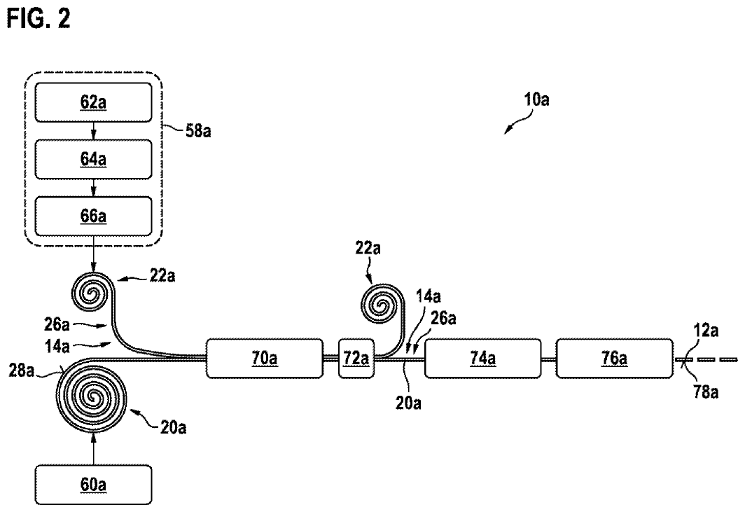

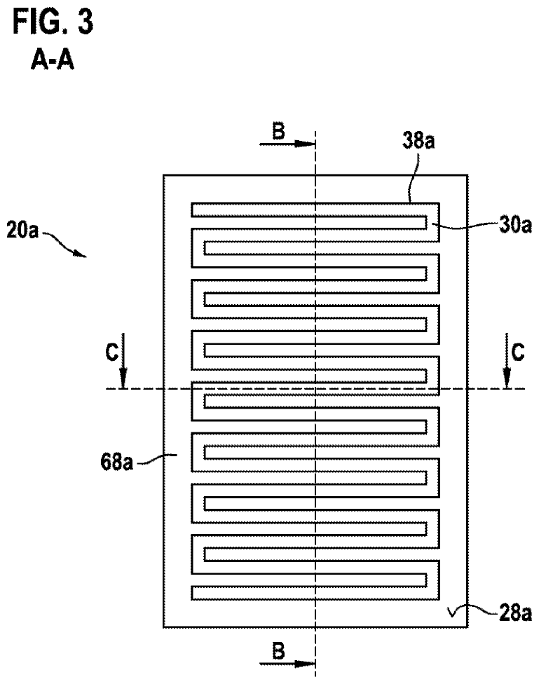

FIG. 1 shows a metal-supported fuel cell and/or electrolyzer unit 12a, in particular a metal-supported solid oxide fuel cell unit. The metal-supported fuel cell and/or electrolyzer unit 12a is produced by a method 10a shown in FIG. 2. The metal-supported fuel cell and/or electrolyzer unit 12a comprises a metal support device 20a. The metal support device 20a is provided for supporting the electrode unit 14a. The metal support device 20a preferably comprises at least one electrode contact surface 28a. The metal-supported fuel cell and/or electrolyzer unit 12a comprises at least one electrode unit 14a. The electrode unit 14a comprises at least two functional layers 16a, 18a. In particular, at least one of the functional layers 16a, 18a is designed as a fuel electrode 48a. In particular, the fuel electrode 48a is provided for contact with a fuel 50a during operation of the fuel cell and/or electrolyzer unit 12a. In particular, at least one of the functional layers 16a, 18a is designed as a separating layer 52a, in particular an electrolyte layer. The fuel cell and/or electrolyzer unit 12a preferably comprises at least one additional functional layer 26a. The additional functional layer 26a is preferably designed as an oxidant electrode 24a. In particular, the oxidant electrode 24a is provided for contact with an oxidant 54a during operation of the fuel cell and/or electrolyzer unit 12a. The additional functional layer 26a designed as an oxidant electrode 24a is preferably arranged on the electrode contact surface 28a of the metal support device 20a. The metal support device 20a preferably comprises at least one fluid-pervious region 56a. In particular, the fluid-pervious region 56a adjoins the electrode contact surface 28a, in particular adjoins a passage for a fluid, in particular the oxidant 54a, through the metal support device 20a to the additional functional layer 26a arranged on the electrode contact surface 28a. The metal support device 20a is preferably of porous design in the fluid-pervious region 56a. In particular, the metal support device 20a comprises at least one fluid channel 30a (cf. FIG. 3), in particular for implementing the fluid-pervious region 56a. The functional layer 18a designed as a separating layer 52a is preferably arranged on the additional functional layer 26a designed as an oxidant electrode 24a. The functional layer 16a designed as a fuel electrode 48a is preferably arranged on the functional layer 18a designed as a separating layer 52a. In particular, the separating layer 52a is arranged between the fuel electrode 48a and the oxidant electrode 24a. In particular, the additional functional layer 26a is disposed between the electrode unit 14a and the metal support device 20a.

FIG. 2 shows the method 10a for producing the metal-supported fuel cell and/or electrolyzer unit 12a, in particular a metal-supported solid oxide fuel cell unit. The electrode unit 14a having the at least two functional layers 16a, 18a, and the metal support device 20a are produced separately from one another. The method 10a preferably comprises an electrode production step 58a. The method 10a preferably comprises a metal support production step 60a. The electrode production step 58a and the metal support production step 60a are preferably performed independently of one another. In particular, the electrode production step 58a and the metal support production step 60a are performed in parallel, successively and/or partially overlapping in time.

The at least two functional layers 16a, 18a are preferably produced, in particular preformed, in the electrode production step 58a. In particular, one green compact each of the functional layers 16a, 18a is produced in the electrode production step 58a. The at least two functional layers 16a, 18a are preferably arranged on one another, in particular fixed to one another, in the electrode production step 58a. Preferably, in the electrode production step 58a, the electrode unit 14a is applied, in particular in layers, to a flexible transport support element 22a, before the electrode unit 14a is applied to the metal support device 20a. Preferably, in at least one fuel electrode application step 62a, the functional layer 16a designed as a fuel electrode 48a is applied, in particular printed, onto the transport support element 22a. For example, at least the functional layer 16a designed as fuel electrode 48a is manufactured at least substantially of NiO/Ni with yttrium-stabilized zirconium oxide, of cerium gadolinium oxide, of a perovskite or the like. Preferably, in at least one electrolyte application step 64a, the functional layer 18a designed as a separating layer 52a is applied, in particular printed, onto the fuel electrode 48a. For example, at least the functional layer 18a designed as a separating layer 52a is manufactured at least substantially of yttrium-stabilized zirconium oxide and/or cerium-gadolinium oxide. In particular, it is conceivable that one of the functional layers 16a, 18a, is constructed from at least two or more sub-layers, wherein in particular different sub-layers are manufactured from different materials. In at least one oxidant electrode application step 66a before the electrode unit 14a is applied to the metal support device 20a, the additional functional layer 26a, in particular designed as an oxidant electrode 24a, is applied, in particular printed, onto the electrode unit 14a. For example, at least the additional functional layer 26a designed as an oxidant electrode 24a is manufactured at least substantially of lanthanum strontium manganese oxide, of lanthanum strontium cobalt ferrite, of lanthanum strontium chromite, or the like. In the electrode production step 58a, the transport support element 22a is preferably rolled up and/or stacked for transport and/or storage after application of the electrode unit 14 and/or of the additional functional layer 26a. It is also conceivable that the transport support element 22a with the electrode unit 14a and/or the additional functional layer 26a is conveyed directly to further processing, e.g. via a conveyor system.

The metal support device 20a is preferably produced in the metal support production step 60a. The metal support device 20a preferably comprises at least one main body 68a, in particular a metal sheet. The metal support device 20a, in particular the main body 68a, is manufactured at least substantially of titanium, Crofer® 22 H/APU, Inconel® 600 or the like, for example. At least the main body 68a, in particular the electrode contact surface 28a, of the metal support device 20a is preferably structured in the metal support production step 60a. In particular, at least one fluid channel 30a is let into the main body 68a in the metal support production step 60a. The at least one fluid channel 30a is preferably let into the main body 68a of the metal support device 20a by means of a forming process, in particular by means of stamping, embossing, milling, laser boring, laser cutting or the like. The metal support device 20a is preferably deburred in the metal support production step 60a. The metal support device 20a is preferably cleaned in the metal support production step 60a. The metal support device 20a is preferably thermally after-treated in the metal support production step 60a. The metal support device 20a is preferably rolled up and/or stacked for transport and/or storage in the metal support production step 60a. It is also conceivable that the metal support device 20a is conveyed directly to further processing, e.g. via a conveyor system.

The electrode unit 14a, in particular together with the additional functional layer 26a, is preferably applied to the metal support device 20a, in particular to the electrode contact surface 28a, in an assembly process 70a. In the assembly process 70a, the transport support element 22a, with the electrode unit 14a and/or the additional functional layer 26a, is preferably arranged on the metal support device 20a. In particular, the additional functional layer 26a faces the metal support device 20a, in particular the electrode contact surface 28a. The assembly process 70a preferably comprises a heat pressing process, in particular for laminating the electrode unit 14a and/or the additional functional layer 26a onto the metal support device 20a, in particular onto the electrode contact surface 28a. In at least one detachment step 72a after application of the electrode unit 14a to the metal support device 20a, the, in particular water-soluble, transport support element 22a is removed for transport of the electrode unit 14a. In particular, the, in particular water-soluble, transport support element 22a is wetted in the detachment step 72a. In particular, the, in particular water-soluble, transport support element 22a is at least partially dissolved in the detachment step 72a. In particular, the, in particular water-soluble, transport support element 22a is detached from the electrode unit 14a, in particular from the functional layer 16a designed as fuel electrode 48a, in the detachment step 72a. It is conceivable that the method 10a comprises a cleaning process of the electrode unit 14a after the detachment step 72a. The method 10a preferably comprises a sintering step 74a. The electrode unit 14a and/or the additional functional layer 26a, in particular in a state applied to the metal support device 20a, is preferably sintered in the sintering step 74a. The electrode unit 14a and/or the additional functional layer 26a, in particular in a state applied to the metal support device 20a, is preferably brought to a temperature of more than 600° C., preferably more than 800° C., preferably more than 1000° C., in the sintering step 74a. It is conceivable that the electrode unit 14a and/or the additional functional layer 26a, in particular in a state applied to the metal support device 20a, is surrounded during sintering by a reduced atmosphere which in particular has an oxygen partial pressure of less than 10⁻¹⁶ bar, preferably of less than 10⁻¹⁷ bar, particularly preferably of less than 10⁻¹⁸ mbar. In a separation step 76a, the metal support device 20a is preferably separated, together with the electrode unit 14a and/or the additional functional layer 26a, into individual metal-supported fuel cell and/or electrolyzer units 12a. After separation in the separation step 76a, a largest outer surface of the metal-supported fuel cell and/or electrolyzer unit 12a preferably comprises a largest area of at least 0.5 cm², preferably of at least 2 cm², particularly preferably of at least 4.5 cm². After separation in the separation step 76a, the largest outer surface of the metal-supported fuel cell and/or electrolyzer unit 12a preferably comprises a largest area of less than 1500 cm², preferably of less than 1000 cm², particularly preferably of less than 550 cm².

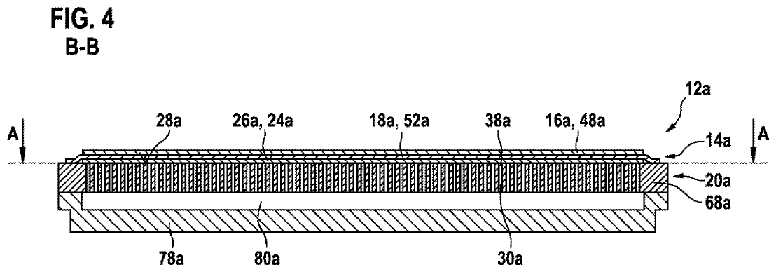

FIG. 3 shows a plan view of the metal support device 20a, in particular of the electrode contact surface 28a. FIG. 4 shows a cross section of the metal support device 20a, in particular of the fuel cell and/or electrolyzer unit 12a. The metal support device 20a for the metal-supported fuel cell and/or electrolyzer unit 12a, in particular for the metal-supported fuel cell and/or electrolyzer unit 12a produced by the method 10a, is provided for supporting the electrode unit 14a of the metal-supported fuel cell and/or electrolyzer unit 12a. The metal support device 20a comprises at least one electrode contact surface 28a. The electrode contact surface 28a is of structured design. In particular, the metal support device 20a comprises precisely one fluid channel 30a. The fluid channel 30a is designed as an aperture through the main body 68a of the metal support device 20a. In particular, the fluid channel 30a comprises an outlet opening 38a. The outlet opening 38a is preferably arranged in a plane containing the electrode contact surface 28a. The metal support device 20a comprises the fluid channel 30a with the large-area outlet opening 38a arranged on the electrode contact surface 28a. In particular, the outlet opening 38a is of meandering design. In particular, the outlet opening 38a comprises at least one turn, preferably a multiplicity of turns. The fuel cell and/or electrolyzer unit 12a is preferably mounted on a gas space plate 78a to form a gas space 80a in at least one method step of the method 10a. In particular, the metal support device 20a is mounted on the gas space plate 78a. It is conceivable that the gas space plate 78a is integrated into the metal support device 20a.

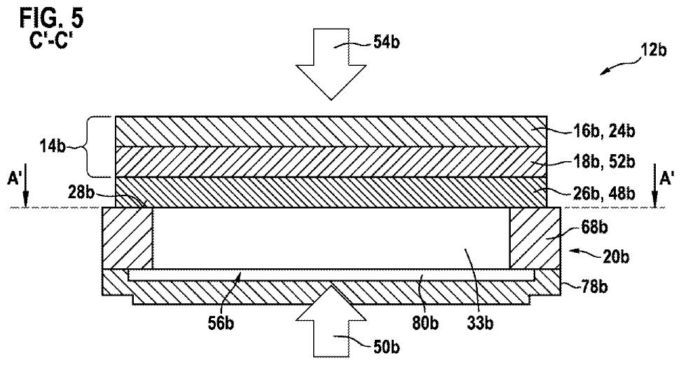

Five further exemplary embodiments of the invention are shown in FIGS. 5 to 13. The following descriptions and the drawings are limited substantially to the differences between the exemplary embodiments, wherein, in respect of components of identical designation, in particular in respect of components with the same reference signs, it is possible in principle also to refer to the drawings and/or the description of the other exemplary embodiments, in particular of FIGS. 1 to 4. To distinguish the exemplary embodiments, the letter a is added as a suffix to the reference signs of the exemplary embodiment in FIGS. 1 to 4. In the exemplary embodiments in FIGS. 5 to 13, the letter a is replaced by the letters b to f.

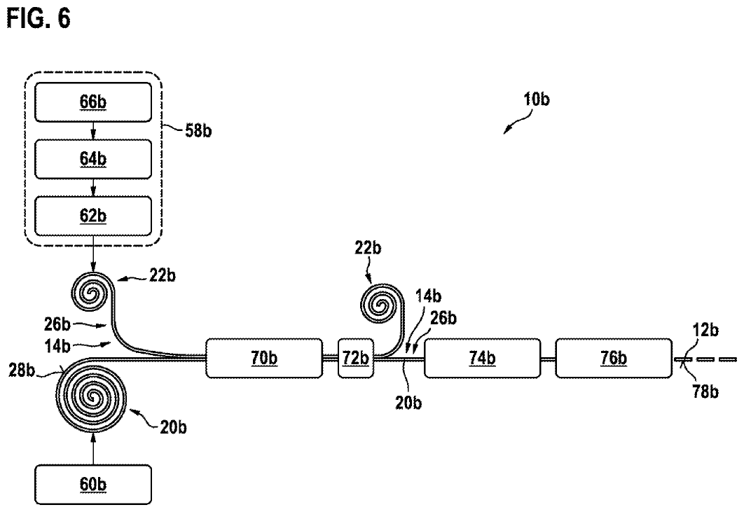

FIG. 5 shows a metal-supported fuel cell and/or electrolyzer unit 12b, in particular a metal-supported solid oxide fuel cell unit. The metal-supported fuel cell and/or electrolyzer unit 12b is produced by the method 10b shown in FIG. 6. The metal-supported fuel cell and/or electrolyzer unit 12b comprises a metal support device 20b. The metal support device 20b is provided for supporting the electrode unit 14b. The metal support device 20a preferably comprises at least one electrode contact surface 28b. The metal-supported fuel cell and/or electrolyzer unit 12b comprises at least one electrode unit 14b. The electrode unit 14b comprises at least two functional layers 16b, 18b. In particular, at least one of the functional layers 16b, 18b is designed as an oxidant electrode 24b. The fuel cell and/or electrolyzer unit 12b preferably comprises at least one additional functional layer 26b. The additional functional layer 26b is preferably designed as a fuel electrode 48b. The additional functional layer 26b designed as a fuel electrode 48b is preferably arranged on the electrode contact surface 28b of the metal support device 20b. In respect of further features and/or functions of the metal-supported fuel cell and/or electrolyzer unit 12b, reference may be made to the description of FIGS. 1 to 4.

FIG. 6 shows the method 10b for producing the metal-supported fuel cell and/or electrolyzer unit 12b, in particular a metal-supported solid oxide fuel cell unit. The metal-supported fuel cell and/or electrolyzer unit 12b comprises at least the electrode unit 14b having the at least two functional layers 16b, 18b. The metal-supported fuel cell and/or electrolyzer unit 12b comprises at least the metal support device 20b for supporting the electrode unit 14b. The electrode unit 14b having the at least two functional layers 16b, 18b, and the metal support device 20b are produced separately from one another. Preferably, in at least one oxidant electrode application step 66b, the functional layer 16b designed as an oxidant electrode 24b is applied, in particular printed, onto a transport support element 22b. Preferably, in at least one electrolyte application step 64a, the functional layer 18b designed as a separating layer 52a is applied, in particular printed, onto the oxidant electrode 24b. Preferably, in at least one fuel electrode application step 62b before application of the electrode unit 14b to the metal support device 20b, the additional functional layer 26b designed as a fuel electrode 48b is applied, in particular printed, onto the electrode unit 14b. In respect of further features and/or functions of the method 10b, reference may be made to the description of FIGS. 1 to 4.

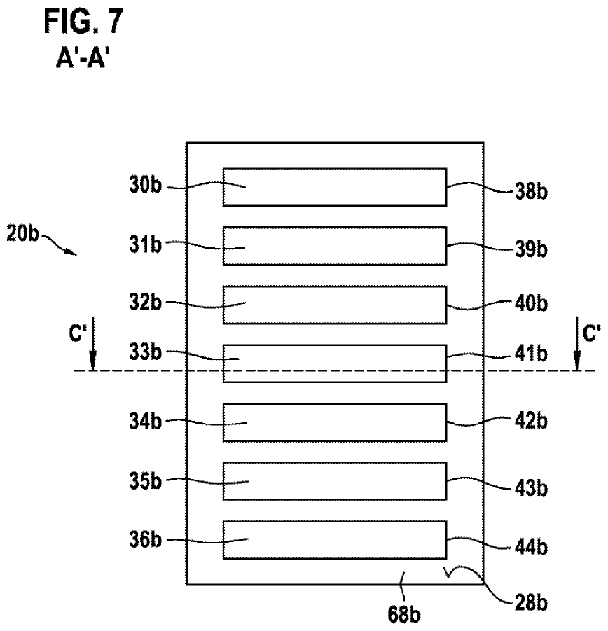

FIG. 7 shows a plan view of the metal support device 20b, in particular of the electrode contact surface 28b of the metal support device 20b. The metal support device 20b for a metal-supported fuel cell and/or electrolyzer unit 12b, in particular for a metal-supported fuel cell and/or electrolyzer unit 12b produced by the method 10b, is provided for supporting the electrode unit 14b of the metal-supported fuel cell and/or electrolyzer unit 12b. The metal support device 20b comprises at least one electrode contact surface 28b. The electrode contact surface 28b is of structured design. The metal support device 20b comprises fluid channels 30b-36b having large-area outlet openings 38b-44b arranged on the electrode contact surface 28b. The metal support device 20b preferably comprises at least two, preferably more than five, fluid channels 30b-36b. The metal support device 20b preferably comprises at least one slot-shaped fluid channel 30b-36b. In particular, the large-area outlet opening 38b-44b of the slot-shaped fluid channel 30b-36b has at least one maximum longitudinal extent in at least one direction which corresponds at least substantially to a maximum extent of the electrode contact surface 28b in said direction. The fluid channels 30b-36b are preferably at least substantially of identical construction. At least two fluid channels 30b-36b are preferably arranged substantially parallel. The fluid channels 30b-36b are preferably arranged at regular and/or irregular intervals from one another. In respect of further features and/or functions of the metal support device 20b, reference may be made to the description of FIGS. 1 to 4.

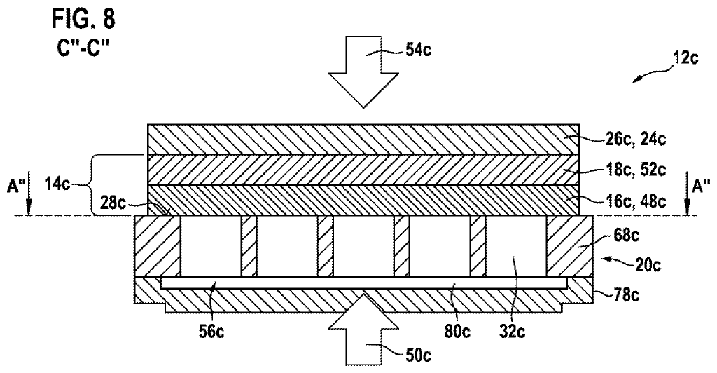

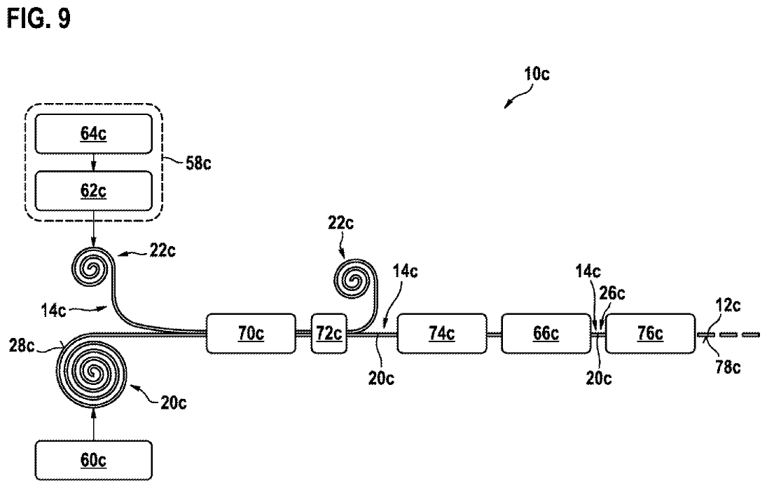

FIG. 8 shows a metal-supported fuel cell and/or electrolyzer unit 12c, in particular a metal-supported solid oxide fuel cell unit. The metal-supported fuel cell and/or electrolyzer unit 12c is produced by a method 10c shown in FIG. 9. The metal-supported fuel cell and/or electrolyzer unit 12c comprises a metal support device 20c. The metal support device 20c is provided for supporting the electrode unit 14c. The metal support device 20c preferably comprises at least one electrode contact surface 28c. The metal-supported fuel cell and/or electrolyzer unit 12c comprises at least one electrode unit 14c. The electrode unit 14c comprises at least two functional layers 16c, 18c. In particular, at least one of the functional layers 16a, 18a is designed as a fuel electrode 48c. The fuel cell and/or electrolyzer unit 12c preferably comprises at least one additional functional layer 26c. The additional functional layer 26c is preferably designed as an oxidant electrode 24c. The electrode unit 14c, in particular the functional layer 16c designed as a fuel electrode 48c, is preferably arranged on the electrode contact surface 28c of the metal support device 20c. The metal support device 20c preferably comprises at least one fluid-pervious region 56c. In particular, the fluid-pervious region 56c adjoins the electrode contact surface 28c, in particular adjoins a passage for a fluid, in particular the fuel 50c, through the metal support device 20c to the electrode unit 14c arranged on the electrode contact surface 28c, in particular to the functional layer 16c designed as a fuel electrode 48c. In particular, the electrode unit 14a is arranged between the additional functional layer 26c and the metal support device 20c. In respect of further features and/or functions of the metal-supported fuel cell and/or electrolyzer unit 12c, reference may be made to the description of FIGS. 1 to 4.

FIG. 9 shows a method 10c for producing the metal-supported fuel cell and/or electrolyzer unit 12c, in particular a metal-supported solid oxide fuel cell unit. The metal-supported fuel cell and/or electrolyzer unit 12c comprises at least one electrode unit 14c having at least two functional layers 16c, 18c. The metal-supported fuel cell and/or electrolyzer unit 12c comprises at least the metal support device 20c for supporting the electrode unit 14b. The electrode unit 14b having the at least two functional layers 16c, 18c, and the metal support device 20b are produced separately from one another. Preferably, in at least one electrolyte application step 64c, the functional layer 18c designed as a separating layer 52c is applied, in particular printed, onto a transport support element 22c. Preferably, in at least one fuel electrode application step 62c the additional functional layer 26c designed as a fuel electrode 48c is applied, in particular printed, onto the separating layer 52c. Preferably, in an oxidant application step 66c after application of the electrode unit 14c to the metal support device 20c, an additional functional layer 26c, in particular designed as an oxidant electrode 24c is applied, in particular baked, onto the electrode unit 14c. The oxidant electrode application step 66c preferably takes place after a sintering step 74c, in particular for sintering the electrode unit 14c arranged on the metal support device 20c. In respect of further features and/or functions of the method 10c, reference may be made to the description of FIGS. 1 to 4.

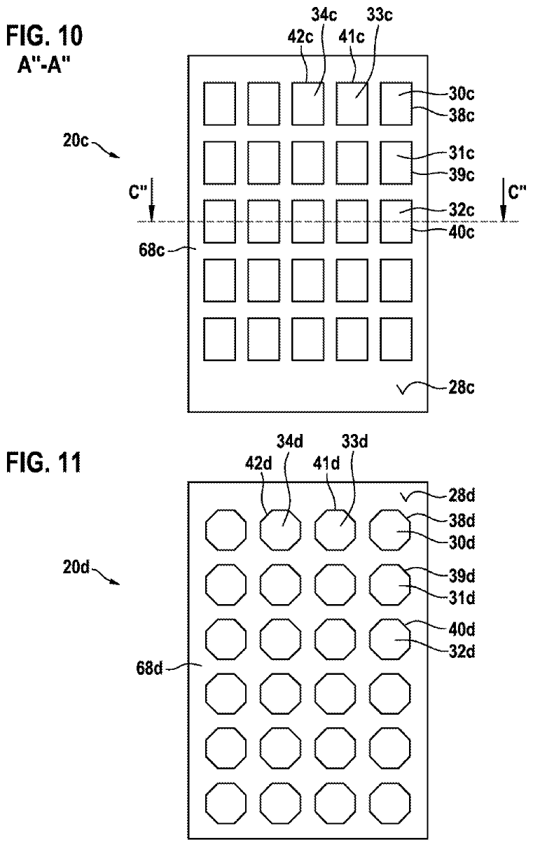

FIG. 10 shows a plan view of a metal support device 20c, in particular of an electrode contact surface 28c of the metal support device 20c. The metal support device 20c for a metal-supported fuel cell and/or electrolyzer unit 12c, in particular for a metal-supported fuel cell and/or electrolyzer unit 12c produced by a method 10c, is provided for supporting an electrode unit 14c of the metal-supported fuel cell and/or electrolyzer unit 12c. The metal support device 20c comprises at least one electrode contact surface 28c. The electrode contact surface 28c is of structured design. The metal support device 20c comprises fluid channels 30c-34c having large-area outlet openings 38c-42c arranged on the electrode contact surface 28c. The metal support device 20c preferably comprises at least two, preferably more than five, particularly preferably more than twenty, fluid channels 30c-34c, which, for the sake of clarity, are not all provided with reference signs here. The metal support device 20c preferably comprises at least one fluid channel 30c-34c having a rectangular outlet opening 38c-42c. The fluid channels 30c-34c are preferably at least substantially of identical construction. The fluid channels 30c-34c are preferably arranged at regular and/or irregular intervals from one another. In respect of further features and/or functions of the metal support devices 20c, reference may be made to the description of FIGS. 1 to 4.

FIG. 11 shows a plan view of a metal support device 20d, in particular of the electrode contact surface 28d of the metal support device 20d. The metal support device 20d for a metal-supported fuel cell and/or electrolyzer unit is provided for supporting an electrode unit 14 of the metal-supported fuel cell and/or electrolyzer unit. The metal support device 20d comprises at least one electrode contact surface 28d. The electrode contact surface 28d is of structured design. The metal support device 20d comprises fluid channels 30d-34d with large-area outlet openings 38d-42d arranged on the electrode contact surface 28d, which, for the sake of clarity, are not all provided with reference signs here. The metal support device 20d preferably comprises at least two, preferably more than five, particularly preferably more than twenty, fluid channels 30d-34d. The metal support device 20d preferably comprises at least one fluid channel 30d-34d having an outlet opening 38d-42d that is rotationally symmetrical, in particular symmetrical with respect to rotation. The fluid channels 30d-34d are preferably at least substantially of identical construction. The fluid channels 30d-34d are preferably arranged at regular and/or irregular intervals from one another. In respect of further features and/or functions of the metal support devices 20d, reference may be made to the description of FIGS. 1 to 4.

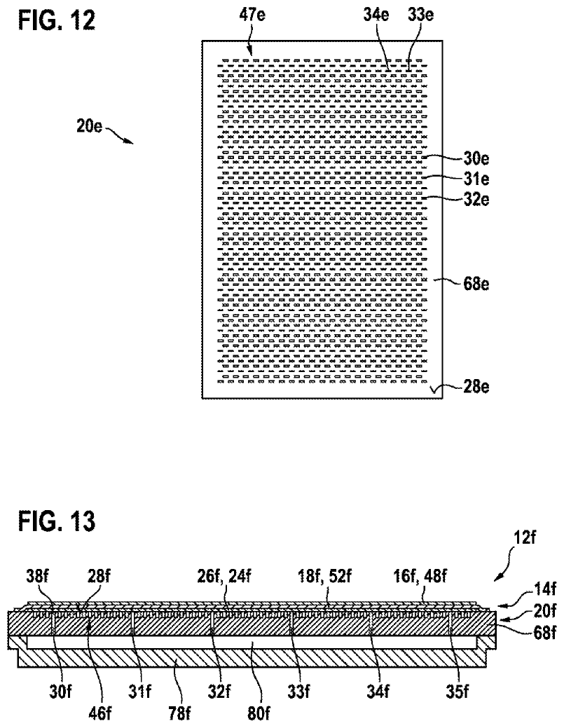

FIG. 12 shows a plan view of a metal support device 20e, in particular of the electrode contact surface 28e of the metal support device 20e. The metal support device 20e for a metal-supported fuel cell and/or electrolyzer unit is provided for supporting an electrode unit 14e of the metal-supported fuel cell and/or electrolyzer unit. The metal support device 20e comprises at least one electrode contact surface 28e. The electrode contact surface 28e is of structured design. The metal support device 20e comprises, in particular for forming the electrode contact surface 28e, an expanded metal element 47e for conducting fluid. In particular, meshes of the expanded metal element 47e form fluid channels 30e-34e of the metal support device 20e, which, for the sake of clarity, are not all provided with reference signs here. It is conceivable that the meshes of the expanded metal element 47e form large-area outlet openings of the fluid channels 30e-34e. In respect of further features and/or functions of the metal support devices 20e, reference may be made to the description of FIGS. 1 to 4.

FIG. 13 shows a cross section through a metal support device 20f, in particular a cross section through a fuel cell and/or electrolyzer unit 12f. The metal support device 20f for the metal-supported fuel cell and/or electrolyzer unit 12f is provided for supporting an electrode unit 14f of the metal-supported fuel cell and/or electrolyzer unit 12f. The metal support device 20f comprises at least one electrode contact surface 28f. The electrode contact surface 28f is of structured design. The metal support device 20f comprises at least one fluid distribution element 46f arranged on the electrode contact surface 28f. In particular, the fluid distribution element 46f comprises a region provided with, in particular, branching and/or spirally arranged grooves for conducting fluid. The metal support device 20f preferably comprises at least one fluid channel 30f-35f, which are designed as supply shafts, in particular as apertures through a main body 68f of the metal support device 20f. In particular, the at least one fluid channel 30f-35f opens into the fluid distribution element 46f

In respect of further features and/or functions of the metal support devices 20f, reference may be made to the description of FIGS. 1 to 4.

In addition, each metal support device 20a-20f shown here is compatible with each method 10a 10b, 10c shown here. In particular, each of the metal support devices 20a-20f can be used for each metal-supported fuel cell and/or electrolyzer unit 12a, 12b, 12c, 12f.

1. A method for producing a metal-supported fuel cell and/or electrolyzer unit, wherein the metal-supported fuel cell and/or electrolyzer unit comprises at least one electrode unit (14a; 14b; 14c; 14f) with at least two functional layers (16a, 18a; 16b, 18b; 16c, 18c; 16f, 18f), and wherein the metal-supported fuel cell and/or electrolyzer unit comprises at least one metal support device for supporting the electrode unit (14a; 14b; 14c; 14f), characterized in that the metal support device and the electrode unit (14a; 14b; 14c; 14f), which has the at least two functional layers (16a, 18a; 16b, 18b; 16c, 18c; 16f, 18f), are produced separately.

2. The method as claimed in claim 1, characterized in that the electrode unit (14a; 14b; 14c; 14f) is applied to a flexible transport support element (22a; 22b; 22c) before application of the electrode unit (14a; 14b; 14c; 14f) to the metal support device.

3. The method as claimed in claim 1, characterized in that, in at least one method step, after the electrode unit (14a; 14b; 14c; 14f) has been applied to the metal support device, a transport support element (22a; 22b; 22c) is removed for the transport of the electrode unit (14a; 14b; 14c; 14f).

4. The method as claimed in claim 1, characterized in that an additional functional layer (26a; 26b) is applied to the electrode unit (14a; 14b) in at least one method step before application of the electrode unit (14a; 14b) to the metal support device.

5. The method as claimed in claim 1, characterized in that an additional functional layer (26c) is applied to the electrode unit (14c) in at least one method step after application of the electrode unit (14c) to the metal support device.

6. A metal support device for a metal-supported fuel cell and/or electrolyzer unit produced by a method as claimed in claim 1, for supporting an electrode unit (14a; 14b; 14c; 14f) of the metal-supported fuel cell and/or electrolyzer unit with at least one electrode contact surface (28a; 28b; 28c; 28d; 28e; 28f), characterized in that the electrode contact surface (28a; 28b; 28c; 28d; 28e; 28f) is of structured design.

7. The metal support device as claimed in claim 6, characterized by at least one fluid channel (30a; 30b-36b; 30c-34c; 30d-34d) having a large-area outlet opening (38a; 38b-44b; 38c-42c; 38d-42d) arranged on the electrode contact surface (28a; 28b; 28c; 28d).

8. The metal support device as claimed in claim 6, characterized by a fluid distribution element (46f) arranged on the electrode contact surface (28f).

9. The metal support device as claimed in claim 6, characterized in that the metal support device comprises an expanded metal element (47e) for conducting fluid.

10. (canceled)

11. The method as claimed in claim 1, wherein the unit is a metal-supported solid oxide fuel cell unit.

12. The method as claimed in claim 2, wherein the electrode unit (14a; 14b; 14c; 14f) is applied in layers.

13. The method as claimed in claim 3, wherein the transport support element (22a; 22b; 22c) is a water-soluble transport support element.

14. The method as claimed in claim 4, wherein the additional functional layer (26a; 26b) is an oxidant electrode (24a).

15. The method as claimed in claim 5, wherein the additional functional layer (26c) is an oxidant electrode (24c).

16. The metal support device as claimed in claim 9, wherein the expanded metal element (47e) for conducting fluid is for the formation of the electrode contact surface (28e).
